(19) United States
(12) Patent Application Publication
(10) Pub. No.: US 2016/0073608 A1
(43) Pub. Date: Mar. 17, 2016

(54) Animal enclosure

(71) Applicant: SHANLUE HUANG, Guangdong (CN)

(72) Inventor: SHANLUE HUANG, Guangdong (CN)

(21) Appl. No.: 14/485,653

(22) Filed: Sep. 12, 2014

(51) Int. Cl. A01K 1/03

(52) U.S. Cl. CPC A01K 1/034

(57) ABSTRACT

An animal enclosure that contains an animal within a defined area. The animal enclosure includes a main enclosure with four sides, one of which includes a gate. The gate can be opened to allow access through the panel by the animal. The animal enclosure also includes a secondary enclosure with three panels that is rotatably affixed to the main enclosure. When in a first position, the secondary enclosure creates a secondary containment area bounded by the three panels of the secondary enclosure, and one panel of the main enclosure. When in a second position, the secondary enclosure acts as a fifth panel to the main enclosure.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

1. Field of the Invention

This invention relates to the general field of enclosures, and more specifically toward an animal enclosure that contains an animal within a defined area. The animal enclosure includes a main enclosure with four sides, one of which includes a gate. The gate can be opened to allow access through the panel by the animal. The animal enclosure also includes a secondary enclosure with three panels that is rotatably affixed to the main enclosure. When in a first position, the secondary enclosure creates a secondary containment area bounded by the three panels of the secondary enclosure, and one panel of the main enclosure. When in a second position, the secondary enclosure acts as a fifth panel to the main enclosure.

Pets, such as dogs, cats, bunnies and guinea pigs, are loved and cared for by many families. Animal enclosures provide a living space for pets and other animals. Such enclosures help contain animals within a defined area for the safety of the animal contained with the enclosure as well as their owners, keepers, and other animals around the enclosure. In particular situations, it is beneficial to provide additional living space to the animal, whereby the animal can exit a main enclosure and travel about a secondary enclosure. In other situations, it is beneficial to provide an enclosure that uses four panels to surround the animal, as well as a roof to prevent the animal from escaping the enclosure out the top.

Thus there has existed a long-felt need for an animal enclosure that provides for restricted access to a main enclosure with a secondary living area that can convert to an animal enclosure with a roof panel over the main enclosure area.

### SUMMARY OF THE INVENTION

The current invention provides just such a solution by having an animal enclosure that contains an animal within a defined area. The animal enclosure includes a main enclosure with four sides, one of which includes a gate. The gate can be opened to allow access through the panel by the animal. The animal enclosure also includes a secondary enclosure with three panels that is rotatably affixed to the main enclosure. When in a first position, the secondary enclosure creates a secondary containment area bounded by the three panels of the secondary enclosure, and one panel of the main enclosure. When in a second position, the secondary enclosure acts as a fifth panel to the main enclosure.

The secondary enclosure forms a “U” shape, with each arm of the U shape being secured to the main enclosure. The secondary enclosure is secured to the main enclosure via screws, bolts, or other fasteners that enable the secondary enclosure to rotate about the main enclosure. Additional fasteners, such as screws or bolts can be used to secure the main enclosure and secondary enclosure such that rotational movement is restricted in either the first or second position.

It is a principal object of the invention to provide an animal enclosure with a main living area and a secondary living area.

It is another object of the invention to provide an animal enclosure that has side panels and a roof that prevents an animal from escaping over the side panels.

It is a further object of this invention to provide an animal enclosure that converts from having a secondary living area to an enclosure with a roof panel.

A particular embodiment of the current disclosure provides for an animal enclosure comprising a main enclosure and a secondary enclosure, where the main enclosure comprises a front panel, a back panel, and two side panels, where the front panel is secured to each of the two side panels, where the back panel is secured to each of the two side panels, where the front panel comprises a gate, where the gate comprises a latch; where the secondary enclosure comprises two side panels and a front panel, where the front panel is secured to each of the side panels; where each side panel of the secondary enclosure is rotatably secured to the main enclosure using fasteners thereby rotatably securing the secondary enclosure to the main enclosure. The animal enclosure further comprises an additional fastener, where the additional fastener is secured to one of the side panels of the secondary enclosure and restricts rotational movement of the secondary enclosure relative to the main enclosure. The additional fastener secures one of the two side panels of the main enclosure to one of the two side panels of the secondary enclosure. The secondary enclosure can rotate about the main enclosure from a first position to a second position, particularly the enclosure can rotate ninety degrees about the main enclosure from a first position to a second position. The second position forms an enclosure with five sides. The first position forms two containment areas, where the first containment area is bounded by the two side panels, front panel, and back panel of the main enclosure, and where the second containment area is bounded by the two side panels and front panel of the secondary enclosure along with the front panel of the main enclosure. The latch of the gate engages the front panel.

Another embodiment of the current disclosure provides for an enclosure comprising a main enclosure and a secondary enclosure, where the main enclosure comprises a front panel, a back panel, and two side panels, where the front panel is secured to each of the two side panels, where the back panel is secured to each of the two side panels, where the front panel comprises a gate; where the secondary enclosure comprises two side panels and a front panel, where the front panel is secured to each of the side panels; where the secondary enclosure is rotatably secured to the main enclosure. The enclosure further comprises a fastener, where the fastener restricts rotational movement of the secondary enclosure relative to the main enclosure. The fastener secures one of the two side panels of the main enclosure to one of the two side panels of the secondary enclosure. The secondary enclosure can rotate about the main enclosure from a first position to a second position, particularly the secondary enclosure can rotate ninety degrees about the main enclosure from a first position to a second position. The second position forms an enclosure with five sides. The first position forms two containment areas, where the first containment area is bounded by the two side panels, front panel, and back panel of the main enclosure, and where the second containment area is bounded by the two side panels and front panel of the secondary enclosure along with the front panel of the main enclosure. The gate further comprises a latch, where the latch engages the front panel. The front panel of the secondary enclosure is secured to the side panels by screws. The secondary enclosure is secured to the main enclosure by at least two screws.

An additional embodiment of the current disclosure provides for an animal enclosure comprising a main enclosure and a secondary enclosure, where the main enclosure comprises a front panel, a back panel, and two side panels, where the front panel is secured to each of the two side panels, where the back panel is secured to each of the two side panels, where each side panel is secured to the front panel and the back panel, where the front panel comprises a gate, where the gate comprises a latch; where the secondary enclosure comprises two side panels and a front panel, where the front panel is secured to each of the side panels, where each side panel is secured to the front panel; where each side panel of the secondary enclosure is rotatably secured to the main enclosure using fasteners thereby rotatably securing the secondary enclosure to the main enclosure, where the secondary enclosure can rotate about the main enclosure from a first position to a second position, where the second position forms an enclosure with five sides, where the first position forms two containment areas, where the first containment area is bounded by the two side panels, front panel, and back panel of the main enclosure, and where the second containment area is bounded by the two side panels and front panel of the secondary enclosure along with the front panel of the main enclosure. The latch of the gate engages the front panel.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is an exploded view of the main enclosure according to selected embodiments of the current disclosure.

FIG. 2 is a perspective view of the main enclosure according to selected embodiments of the current disclosure.

FIG. 3 is an exploded view of the secondary enclosure according to selected embodiments of the current disclosure.

FIG. 4 is a perspective view of the secondary enclosure according to selected embodiments of the current disclosure.

FIG. 5 is a partially-exploded view of the animal enclosure with a main enclosure and secondary enclosure according to selected embodiments of the current disclosure.

FIG. 6 is a perspective view of the animal enclosure with the secondary enclosure in a first position according to selected embodiments of the current disclosure.

FIG. 7 is a partially-exploded perspective view of the animal enclosure with the secondary enclosure partially rotated according to selected embodiments of the current disclosure.

FIG. 8 is a perspective view of the animal enclosure with the secondary enclosure in a second position according to selected embodiments of the current disclosure.

FIG. 9 is a perspective view of the animal enclosure with the secondary enclosure partially rotated according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

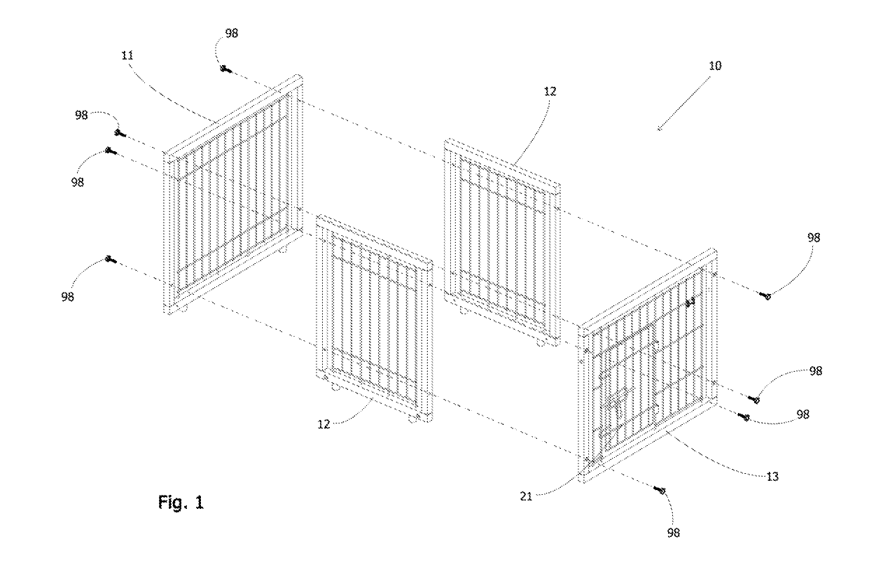

FIG. 1 is an exploded view of the main enclosure according to selected embodiments of the current disclosure. The main enclosure (10) includes a back panel (11), two side panels (12) and a front panel (13). The back panel (11) is secured to the two side panels (12) by four fasteners (98), with two fasteners used for each side panel (12). Likewise, the front panel (13) is secured to the two side panels (12) by four fasteners (98), with two fasteners used for each side panel (12). The panels are easily assembled when holes are pre-drilled into the panels, wherein a screw is easily threaded through the holes to secure the respective panels together.

A gate (21) is incorporated into the front panel (13). When the gate (21) is secured in a closed position (such as when a latch, disclosed in more detail below, engages the front panel (13), an animal contained within the enclosure cannot exit through the front panel (13). However, when the gate (21) is open, the animal can exit the main enclosure through the front panel (13).

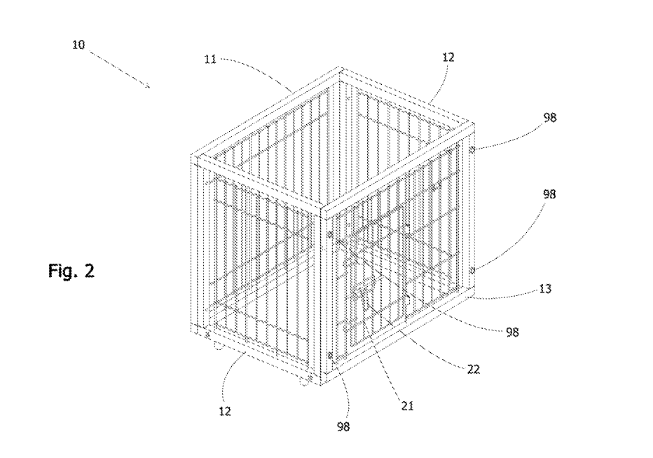

FIG. 2 is a perspective view of the main enclosure according to selected embodiments of the current disclosure. The front panel (13) of the main enclosure (10) is secured to two side panels (12), where two fasteners are used to secure each side panel (12) to the front panel (13). Each of the side panels (12) is also secured to the back panel (11) using fasteners (not shown in this figure). The gate (21) of the front panel (13) includes a latch (22). When the latch (22) engages the front panel (13), the gate (21) is locked closed. When the latch (22) is disengaged from the front panel (13), the gate is allowed to open, and animals can travel through the front panel (13).

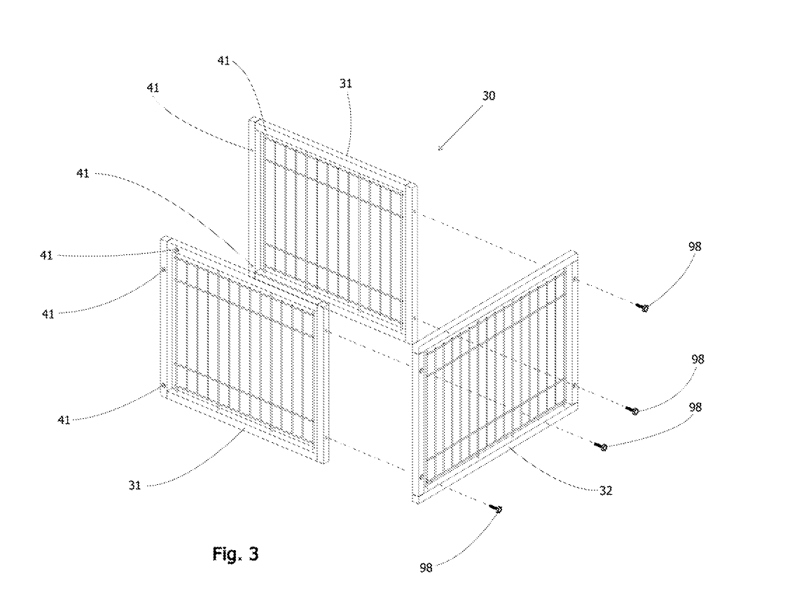

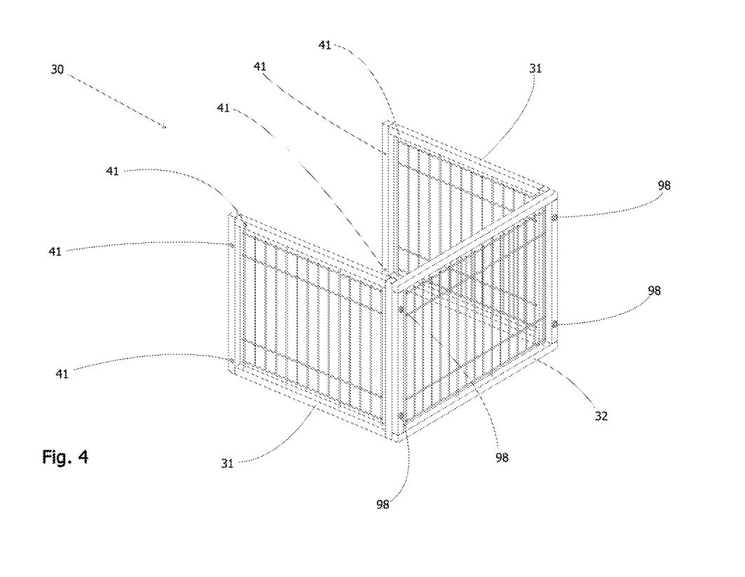

FIG. 3 is an exploded view of the secondary enclosure according to selected embodiments of the current disclosure. FIG. 4 is a perspective view of the secondary enclosure according to selected embodiments of the current disclosure. The secondary enclosure includes a front panel (32) and two side panels (31). The front panel (32) of the secondary enclosure (30) is secured to two side panels (31) using four fasteners (98), with two fasteners (98) used for each side panel (31). Each side panel (31) also includes attachment holes (41) for securing the secondary enclosure to the main enclosure. The panels are easily assembled when holes are pre-drilled into the panels, wherein a screw is easily threaded through the holes to secure the respective panels together.

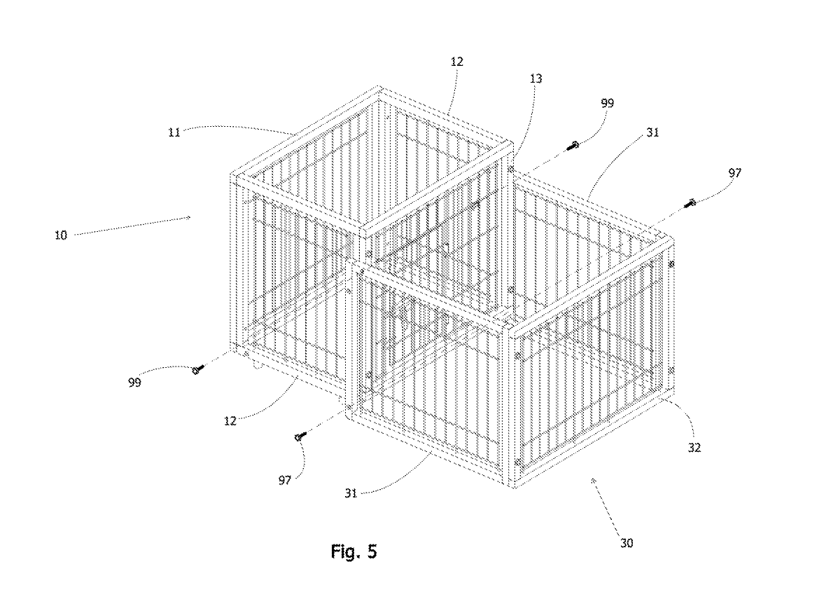

FIG. 5 is a partially-exploded view of the animal enclosure with a main enclosure and secondary enclosure according to selected embodiments of the current disclosure. The main enclosure (10) is secured to the secondary enclosure (30) by fastener (97). Fastener (97), while securing the secondary enclosure (30) to the main enclosure (10) does allow the secondary enclosure (30) to rotate relative to main enclosure (10) about an axis running along the length of fastener (97). Two additional fasteners (99) are secured through side panels (31) of the secondary enclosure (30). In the embodiment shown in this figure, the fasteners (99) extend through holes in the side panel (31) of the secondary enclosure (30) such that the fastener (99) protrudes through the inner side of each side panel (31). The protruding fastener (99) restricts the rotational movement of the secondary enclosure (30) such that the secondary enclosure (30) cannot rotate over the main enclosure (10). In an alternative embodiment, fasteners (99) extend through both the side panel (31) of the secondary enclosure (30) and the side panel (12) of the of the main enclosure (10), thereby restricting the rotational movement of the secondary enclosure (30) relative to the main enclosure (10).

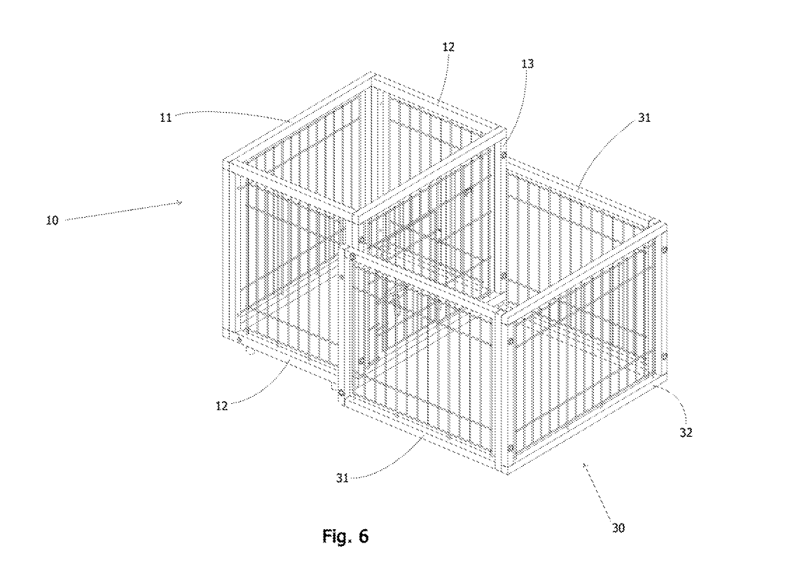

FIG. 6 is a perspective view of the animal enclosure with the secondary enclosure in a first position according to selected embodiments of the current disclosure. The main enclosure (10), being the main living area or first containment area for an animal residing therein, is secured to a secondary enclosure (30), which in this figure is in a first position. The secondary enclosure provides a second living area or second containment area, sometimes called a yard area, that is separate from the main living area.

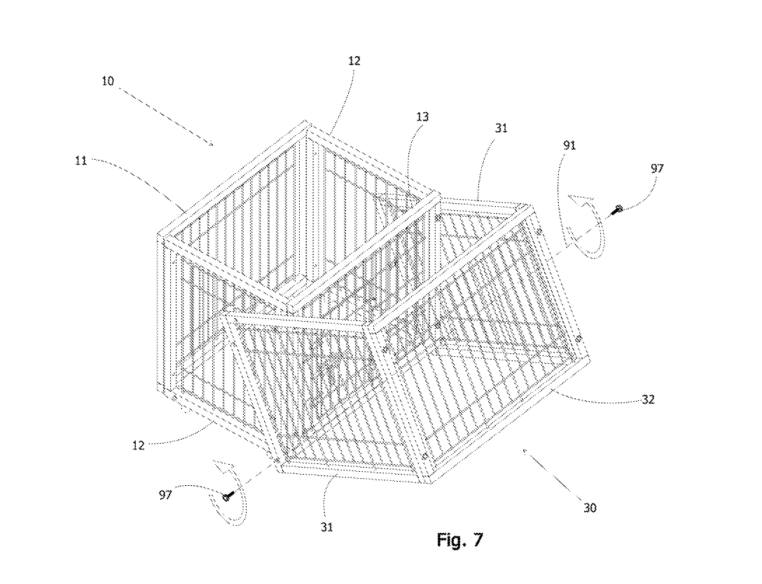

FIG. 7 is a partially-exploded perspective view of the animal enclosure with the secondary enclosure partially rotated according to selected embodiments of the current disclosure. The secondary enclosure (30) is partially rotated about an axis that extends through fasteners (97). Fasteners (97) secure the secondary enclosure (30) to the main enclosure (10), but allow the secondary enclosure (30) to rotate relative to the main enclosure (10).

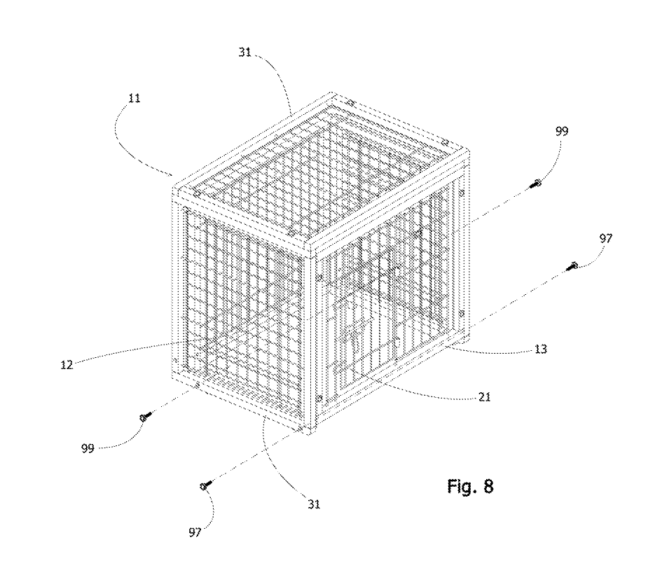

FIG. 8 is a perspective view of the animal enclosure with the secondary enclosure in a second position according to selected embodiments of the current disclosure. The secondary enclosure is in a second position, which is rotated ninety degrees from the first position. The front panel (31) of the secondary enclosure acts as a roof panel when the secondary enclosure is in the second position. The secondary enclosure (30) and main enclosure (10) have side panels (12 and 31) that are adjacent to each other. Fasteners (99) extend through the side panel (31) of the secondary enclosure (30) and the side panel (12) of the main enclosure (10) to restrict rotational movement of the secondary enclosure (30) relative to the main enclosure (10) and lock it in place. With the secondary enclosure in the second position, the animal enclosure will enclose an animal on at least five sides, with the front panel (13), back panel (11), and side panels (12 and 31) enclosing the animal on four sides, and the front panel (31) enclosing the animal on a fifth side.

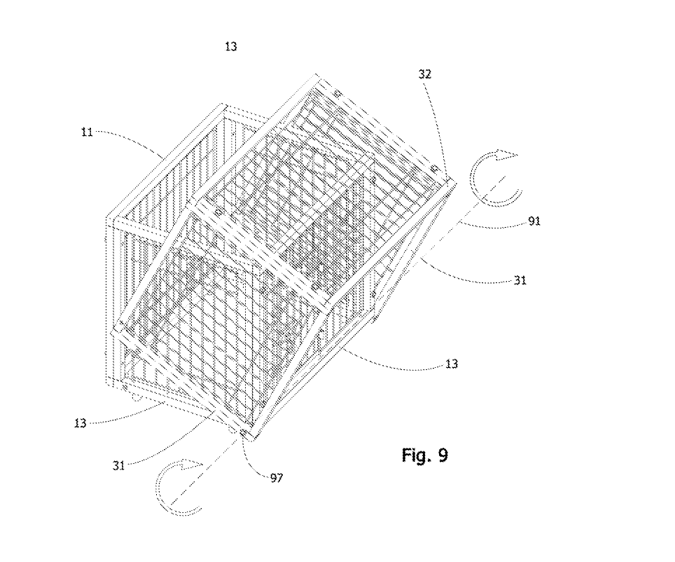

FIG. 9 is a perspective view of the animal enclosure with the secondary enclosure partially rotated according to selected embodiments of the current disclosure. The secondary enclosure (30) is shown being rotated in an opposition direct as that shown in FIG. 7, but still about an axis that extends along the length of fasteners (97).

Fasteners (98) and fasteners (99) can be screws, bolts, and/or other similar means of attaching two members together. Fasteners (97) can also be screws, bolts, and other similar means to secure two members together, and where the fastener (97) enables one member to rotate relative to the other member about the axis of the fastener, while still securing the two members together.

One embodiment of the current disclosure provides for a main enclosure with a floor panel. The floor panel would be secured to the front panel, back panel and side panels of the main enclosure. When the secondary enclosure is in a second position, the floor panel is opposite of the front panel of the secondary enclosure. Thus, a completely enclosed animal enclosure can be formed, wherein the animal is enclosed on all six sides.

The panels can be manufactured from various different materials, including wood, metal, plastic, and combinations thereof.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

1. An animal enclosure comprising a main enclosure and a secondary enclosure,
where the main enclosure comprises a front panel, a back panel, and two side panels, where the front panel is secured to each of the two side panels, where the back panel is secured to each of the two side panels, where the front panel comprises a gate, where the gate comprises a latch;
where the secondary enclosure comprises two side panels and a front panel, where the front panel is secured to each of the side panels;
where each side panel of the secondary enclosure is rotatably secured to the main enclosure using fasteners thereby rotatably securing the secondary enclosure to the main enclosure.

2. The animal enclosure of claim 1, further comprising an additional fastener, where the additional fastener is secured to one of the side panels of the secondary enclosure and restricts rotational movement of the secondary enclosure relative to the main enclosure.

3. The animal enclosure of claim 2, where the additional fastener secures one of the two side panels of the main enclosure to one of the two side panels of the secondary enclosure.

4. The animal enclosure of claim 1, wherein the secondary enclosure can rotate about the main enclosure from a first position to a second position.

5. The animal enclosure of claim 1, wherein the secondary enclosure can rotate ninety degrees about the main enclosure from a first position to a second position.

6. The animal enclosure of claim 4, wherein the second position forms an enclosure with five sides.

7. The animal enclosure of claim 4, wherein the first position forms two containment areas, where the first containment area is bounded by the two side panels, front panel, and back panel of the main enclosure, and where the second containment area is bounded by the two side panels and front panel of the secondary enclosure along with the front panel of the main enclosure.

8. The animal enclosure of claim 1, where the latch of the gate engages the front panel.

9. An enclosure comprising a main enclosure and a secondary enclosure,
where the main enclosure comprises a front panel, a back panel, and two side panels, where the front panel is secured to each of the two side panels, where the back panel is secured to each of the two side panels, where the front panel comprises a gate;
where the secondary enclosure comprises two side panels and a front panel, where the front panel is secured to each of the side panels;
where the secondary enclosure is rotatably secured to the main enclosure.

10. The enclosure of claim 9, further comprising a fastener, where the fastener restricts rotational movement of the secondary enclosure relative to the main enclosure.

11. The enclosure of claim 10, where the fastener secures one of the two side panels of the main enclosure to one of the two side panels of the secondary enclosure.

12. The enclosure of claim 9, wherein the secondary enclosure can rotate about the main enclosure from a first position to a second position.

13. The enclosure of claim 9, wherein the secondary enclosure can rotate ninety degrees about the main enclosure from a first position to a second position.

14. The enclosure of claim 12, wherein the second position forms an enclosure with five sides.

15. The enclosure of claim 12, wherein the first position forms two containment areas, where the first containment area is bounded by the two side panels, front panel, and back panel of the main enclosure, and where the second containment area is bounded by the two side panels and front panel of the secondary enclosure along with the front panel of the main enclosure.

16. The enclosure of claim 9, wherein the gate further comprises a latch, where the latch engages the front panel.

17. The enclosure of claim 9, wherein the front panel of the secondary enclosure is secured to the side panels by screws.

18. The enclosure of claim 9, wherein the secondary enclosure is secured to the main enclosure by at least two screws.

19. An animal enclosure comprising a main enclosure and a secondary enclosure,
where the main enclosure comprises a front panel, a back panel, and two side panels, where the front panel is secured to each of the two side panels, where the back panel is secured to each of the two side panels, where each side panel is secured to the front panel and the back panel, where the front panel comprises a gate, where the gate comprises a latch;
where the secondary enclosure comprises two side panels and a front panel, where the front panel is secured to each of the side panels, where each side panel is secured to the front panel;
where each side panel of the secondary enclosure is rotatably secured to the main enclosure using fasteners thereby rotatably securing the secondary enclosure to the main enclosure, where the secondary enclosure can rotate about the main enclosure from a first position to a second position, where the second position forms an enclosure with five sides, where the first position forms two containment areas, where the first containment area is bounded by the two side panels, front panel, and back panel of the main enclosure, and where the second containment area is bounded by the two side panels and front panel of the secondary enclosure along with the front panel of the main enclosure.

20. The animal enclosure of claim 19, where the latch of the gate engages the front panel.
